(19) United States
(12) Patent Application Publication
(10) Pub. No.: US 2026/0264206 A1
(43) Pub. Date: Sep. 10, 2026

(54) FASTENER DEVICE WITH VARIABLE FEED CYCLE TIMING

(71) Applicant: BLACK & DECKER, INC., New Britain, CT (US)

(72) Inventors: Merrill MYERS, Towson, MD (US); Jongsoo LIM, Timonium, MD (US)

(21) Appl. No.: 19/489,231

(22) PCT Filed: May 30, 2024
(86) PCT No.: PCT/US2024/031666

§ 371 Date: Dec. 1, 2025

Related U.S. Application Data
(60) Provisional application No. 63/505,495, filed on Jun. 1, 2023.
(60) Provisional application No. 63/582,421, filed on Sep. 13, 2023.

(51) Int. Cl. B25C 1/06; B25C 1/00

(52) U.S. Cl. CPC B25C 1/06; B25C 1/001

(57) ABSTRACT

A fastener device (10) comprises a driver (26) having a drive cycle that includes a time from which the driver (26) is activated to engage and drive a fastener in a drive channel into a workpiece to a time until the driver (26) is retracted along the drive axis to clear the drive channel and to allow for feeding of a subsequent fastener into the drive channel; a feeder (110) configured to feed the fastener into the drive channel prior to the driver (26) driving the fastener into the workpiece, the feeder (110) having a start time defining a time at which the feeder (110) is activated to feed the subsequent fastener into the drive channel, and a controller (C) configured to control a time between the drive cycle and the feeder start time based on at least one of a mode of operation of the fastener device (10) and a characteristic of an energy assembly (EA).

### CROSS REFERENCE TO RELATED APPLICATIONS

This application claims priority to U.S. Provisional Patent Application Ser. No. 63/505,495, filed on Jun. 1, 2023, and U.S. Provisional Application Ser. No. 63/582,421, filed on Sep. 13, 2023, the contents of above-identified applications which are hereby incorporated by reference in their entirety.

### FIELD

The patent application relates, in general, to the field of power tools. In particular, this patent application relates to portable fastening or driving tools, such as a nailers and staplers.

### BACKGROUND

Fastener devices/tools, such as nailers and staplers, are relatively commonplace in the construction trades. Several types of nailers have been introduced to the market in an effort to satisfy the demands of modern consumers. Some of the nailers use a spring-loaded device to push fasteners into position such that a drive mechanism or driver may then be actuated to drive or push a fastener into a workpiece.

Fastener device/tools may typically include a drum for storing a coil of collated fasteners and a feed mechanism or a feeder configured to feed the fasteners into a nosepiece/nose assembly of the fastener tool/device. These fastener devices/tools are known in the art for attaching a series or a succession of nails or fasteners into workpieces. The fastener devices can be battery powered or pneumatic powered. The fastener device can engage a transmission and a motor to drive a fastener. Yet the coordinated driving and feeding of fasteners may be improved.

The present patent application provides improvements in the fastener devices.

### SUMMARY

One aspect of the present patent application provides a fastener device that drives a fastener into a workpiece is provided. The fastener device includes a housing, a nose assembly, a driver, an energy assembly, a feeder, and a controller. The nose assembly is connected with the housing. The nose assembly includes a drive channel into which the fastener to be driven into the workpiece is fed. The driver is disposed in the nose assembly. The driver is movable along a drive axis of the nose assembly to engage and drive the fastener in the drive channel into the workpiece. The driver includes a drive cycle that includes a time from which the driver is activated to engage and drive the fastener in the drive channel into the workpiece to a time until the driver is retracted along the drive axis to clear the drive channel and to allow for feeding of a subsequent fastener into the drive channel. The energy assembly is disposed within the housing. The energy assembly is configured to transmit power to the driver to cause the driver to move along the drive axis. The feeder is configured to feed the fastener into the drive channel of the nose assembly prior to the driver driving the fastener into the workpiece. The feeder includes a start time defining a time at which the feeder is activated to feed the subsequent fastener into the drive channel. The controller includes one or more processors and is operatively connected to the energy assembly and the feeder. The controller is configured to control a time between the drive cycle and the feeder start time based on at least one of a mode of operation of the fastener device and a characteristic of the energy assembly.

These and other aspects of the present patent application, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one embodiment of the present patent application, the structural components illustrated herein are drawn to scale. It is to be expressly understood, however, that the drawings are for the purpose of illustration and description only and are not intended as a definition of the limits of the present patent application. It shall also be appreciated that the features of one embodiment disclosed herein can be used in other embodiments disclosed herein. As used in the specification and in the claims, the singular form of “a”, “an”, and “the” include plural referents unless the context clearly dictates otherwise.

Other aspects, features, and advantages of the present patent application will become apparent from the following detailed description, the accompanying drawings, and the appended claims.

### BRIEF DESCRIPTION OF THE DRAWINGS

FIG. 1 shows an exemplary fastener device according to an embodiment of the present patent application;

FIG. 2 shows another exemplary fastener device according to another embodiment of the present patent application;

FIG. 3 is a schematic representation showing electrical and mechanical connections between a controller. a drive actuator, a feed actuator, a motor. a flywheel, and sensors, as well as some switches included in the fastener device according to an embodiment of the present patent application;

FIG. 4 is a schematic representation showing the drive cycle, the feed cycle and a time between the drive cycle and the feeder start time according to an embodiment of the present patent application, wherein the drive cycle, the feed cycle and the time between the drive cycle and the feeder start time are shown for both a sequential operation mode and a bump operation mode; and

FIG. 5 is another schematic representation showing the drive cycle, the feed cycle and a time between the drive cycle and the feeder start time according to an embodiment of the present patent application, wherein the drive cycle, the feed cycle and the time between the drive cycle and the feeder start time are shown for both a sequential operation mode and a bump operation mode.

### DETAILED DESCRIPTION

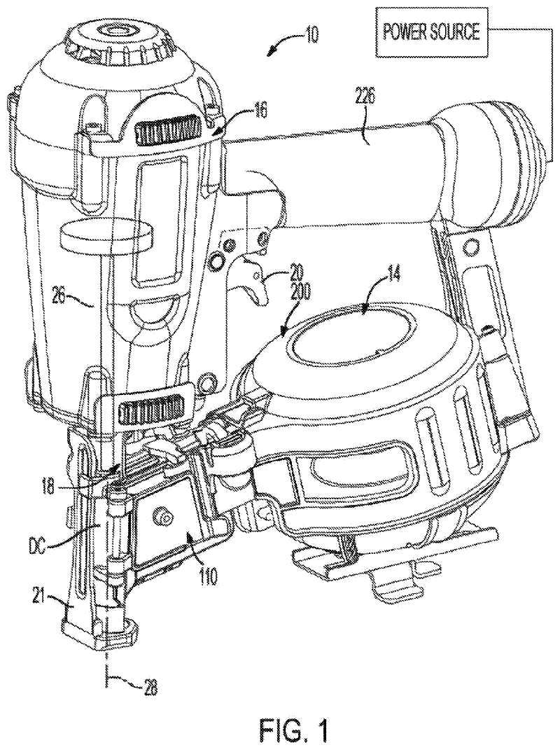

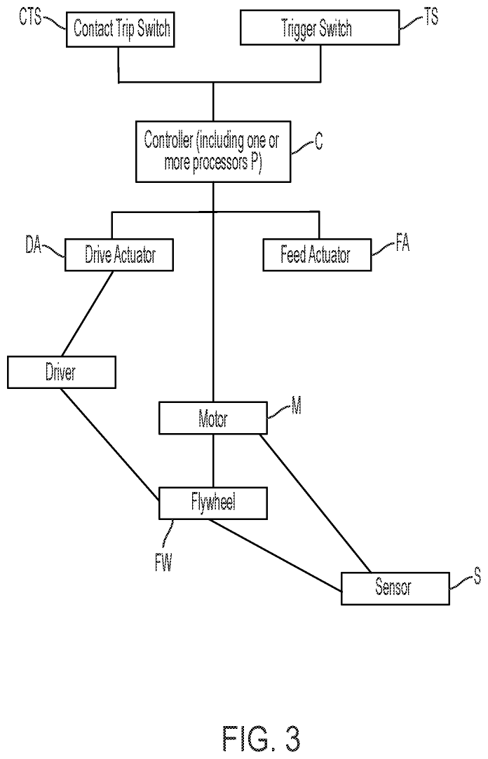

In one embodiment of the present patent application, referring to FIGS. 1-3, a fastener device 10 that drives a fastener (not shown) into a workpiece (not shown) is provided. The fastener device 10 includes a housing 16, a nose assembly 18, a driver 26, an energy assembly, a feeder 110, and a controller C. The nose assembly 18 is connected with the housing 16. The nose assembly 18 includes a drive channel DC into which the fastener to be driven into the workpiece is fed. The driver 16 is disposed in the nose assembly 18. The driver 26 is movable along a drive axis or an axis 28 of the nose assembly 18 to engage and drive the fastener in the drive channel DC into the workpiece. The driver 26 includes a drive cycle that includes a time from which the driver 26 is activated to engage and drive the fastener in the drive channel DC into the workpiece to a time until the driver 26 is retracted along the drive axis 28 to clear the drive channel DC and to allow for feeding of a subsequent fastener into the drive channel DC. The energy assembly is disposed within the housing 16 and will be described in detail below. The energy assembly is configured to transmit power to the driver 26 to cause the driver 26 to move along the drive axis 28. The feeder 110 is configured to feed the fastener into the drive channel DC of the nose assembly 18 prior to the driver 26 driving the fastener into the workpiece. The feeder 110 includes a start time defining a time at which the feeder 110 is activated to feed the subsequent fastener into the drive channel DC. The controller C includes one or more processors P and is operatively connected to the energy assembly and the feeder 110. The controller C is configured to control a time between the drive cycle and the feeder start time based on at least one of a mode of operation of the fastener device 10 and a characteristic of the energy assembly.

This patent application relates, in general, to the field of power tools. For example, this patent application relates to corded or cordless, portable fastener driving tools, such as a nailers and staplers, and improvements made therein to coordinate both driving capabilities and feeding features associated therewith. In particular, the tool may include two actuators—one for driving a fastener, another for feeding the fastener, which are controlled by the controller C, along with a motor M, in order to drive and load fasteners in succession and, in some cases, ready the fastener device such that shot-to-shot time of fasteners is increased.

The fastener device 10 may be interchangeably referred to as a fastener driver, a fastener driving tool, a fastener tool, a fastener driving device, a nailer, a device, or a tool that is adapted to drive fastener(s) into the workpiece. The fasteners may be staples, U-shaped staples, brads, nails, fasteners, and the like. The fastener and the nail may be used interchangeably, In one embodiment, the fasteners may be collated. The fastener device 10 may be a cordless power tool, in accordance with an embodiment. In one embodiment, the fastener device 10 is a nailer configured to drive nail(s) into the workpiece.

In one embodiment, the fastener device 10 may include a flywheel nailer mechanism with a flywheel FW. The flywheel nailer mechanism is described in detail below. The flywheel nailer mechanism may have a wide variation in time from start to finish depending upon the application (e.g., nail length, nail type, density of the workpiece, orientation of the workpiece, etc.). The flywheel nailers with electromechanical nail feeding mechanisms and critical rate of drive requirements may need to account for a longer nail driving cycle when determining the timing of the nail feeding cycle in order to avoid a jam condition caused by feeding the nail/fastener prematurely. This patent application provides a nailer/a fastener driver with a variable feeding mechanism timing. That is, the nailer includes a driving mechanism and a feeding mechanism with some means to control and change the timing between the driving mechanism cycle start and the subsequent feeding mechanism cycle. In one embodiment, a pneumatic type nailer/fastener driver can use linkage tied to mode select to adjust pneumatic valving of the feed mechanism. In another embodiment, electromechanical type nailer/fastener driver can use a firmware algorithm to control the feeding cycle timing. In yet another embodiment, the nailer/fastener driver can use a combination of mechanical and algorithms to control the feeding cycle timing.

The housing 16 may be formed from molded parts. In one embodiment, a first side part and a second side part of the housing 16 may be molded and joined together to encapsulate parts of the fastener driving mechanism and fastener feed mechanism (described in greater detail later) within the housing 16. The driving mechanism may be interchangeably referred to as the driver and the feed mechanism may interchangeably referred to as the feeder. The housing 16 may be made of extruded or molded plastic material, for example. The housing 16 may be formed from an Acrylonitrile Butadiene Styrene (ABS) plastic material. These examples materials of the housing 16 should not be limiting. Other materials, such as polycarbonates and/or combinations of materials, may also be used to form the housing 16. The housing 16 has a front end 46 and a back end 52. The housing 16 may include a handle 226 adapted to be gripped by the hand of an operator or user. In one embodiment, the handle 226 extends between a top end and a bottom end of the housing 16. The housing 16 may also conventionally house a trigger 20 and the motor M with the driver 26, which may be selectively translated along the axis 28 to drive the fastener into the workpiece. Further details of the housing 16 are provided in commonly assigned U.S. Pat. No. 7,866,521 (“the '521 Patent”) and U.S. Patent Application Publication No. 2022/0161404 (“the '404 Patent Application”), each of which are commonly assigned and are incorporated by reference in their entirety.

The nose assembly 18 may extend from the housing 16 proximate the magazine (described in detail below) and may be conventionally configured to engage the magazine so as to sequentially receive fasteners therefrom. The nose assembly 18 may also serve in a conventional manner to guide the driver 26 and fastener when the fastener driver 10 has been actuated to install the fastener to a workpiece. The nose assembly 18 further also includes a contact trip assembly 21, which is described in detail below. In addition to the contact trip assembly 21, the nose assembly 18 may include a barrel that forms a part of the drive channel DC for the driver 26 to move within an interior portion thereof and drive a fastener. The nose assembly 18 may be interchangeably referred to as nosepiece. The nose assembly 18 of the fastener device 10 may include one, some, or all features as described in U.S. Pat. No. 9,827,658 and/or U.S. Patent Application Publication No. 10,926,385, both of which are commonly assigned and are incorporated by reference herein in their entireties.

The fastener device 10 may include a magazine assembly 14, which may be coupled to the housing 16. The magazine assembly may be interchangeably referred to as magazine. The magazine assembly may be coupled to the nose assembly and disposed within the housing 16. The magazine assembly 14 is configured to carry a supply of fasteners through a feed channel along a feed channel direction toward the nose assembly 18. The feeder 110 is configured to feed the fastener through the magazine assembly 14 and into the drive channel prior to driving the fastener into the workpiece.

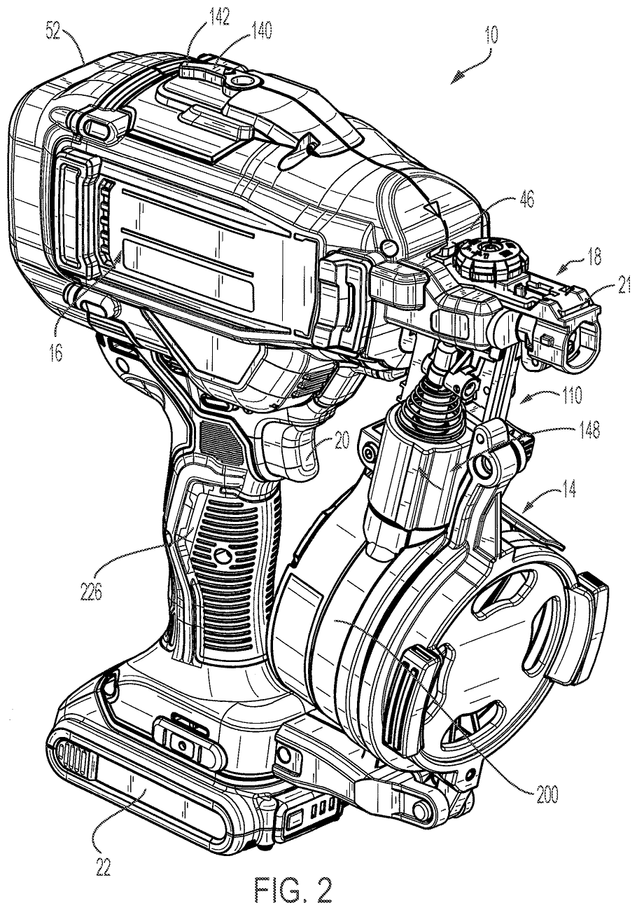

The magazine assembly 14 is an elongated receptacle that extends away from the nose assembly 18, towards a back end of the handle 226. In one embodiment, the magazine assembly 14 may be provided such that it extends between the nosepiece 18 and a base portion of the fastener device 10 (e.g., near a removable battery pack 22 as shown in FIG. 2). In one embodiment, the magazine assembly 14 may be positioned at an acute angle relative to the handle 226 and extending between the nose assembly 18 and a bottom portion of the handle 226, such that a bottom portion of the magazine assembly 14 may be positioned at an acute angle relative to a workpiece when the nose assembly 18 is positioned and is configured for applying the fastener thereto.

The magazine assembly 14 is configured to hold a plurality of fasteners or nails and sequentially feed the fasteners into the nosepiece 18. These fasteners or nails are then configured to be dispensed from the fastener device 10 with sufficient energy to penetrate a workpiece. The magazine assembly 14 may be configured to hold collated nails. The magazine assembly 14 may include a canister 200 (as shown in FIG. 1) that is configured to hold coiled, collated nails/fasteners. The magazine assembly 14 (via its parts therein) is generally configured to sequentially feed/present a lead fastener of the plurality of fasteners into a drive channel DC of the fastener driving tool 10. The magazine assembly 14 may include the feeder or feed mechanism 110, which will be described in detail below. The magazine assembly 14 may be opened to load collated fasteners into the magazine assembly 14 as described in detail in the incorporated '521 Patent. The further details of the magazine assembly 14 are provided in the incorporated '521 Patent and the incorporated '404 Patent Application.

The trigger 20 may be adjacent to or on the handle 226 and may be connected to the controller C (also interchangeably referred to as a control unit or a power control module). The trigger 20 may be provided in the form of a button for manual operation such that when an operator/a user grips the handle 226, the trigger 20 may be engaged by a forefinger of the operator/user. The trigger 20 is mechanically coupled to the handle 226 and is electrically coupled to at least the motor M and controller C such that electric power may be selectively provided thereto. The trigger 20 may be a push button that moves back and forth, or a button that may be pivotally mounted to the housing 16 by way of a pivot, such that application of force via the operator's forefinger moves the trigger 20 relative to the handle 226. The trigger 20 may be associated with a trigger switch/sensor TS. The trigger 20 may also be associated with a contact trip assembly 21 and the controller C.

The contact trip assembly 21 is configured to prevent accidental activation of the fastener device 10. Generally, an operator of the fastener device 10 may hold or grip the fastener device 10 by providing their hand around the handle 226 and place the nose assembly 18 at a desired location for applying a fastener, push down on the contact trip assembly 21, and depress the trigger 20 in order to activate the controller C and the internal actuators (as described in detail later) and to cause a fastener to be ejected at that desired location. In one embodiment, the contact trip assembly 21 may be provided on the nose assembly 18. The contact trip assembly 21 may be coupled to the nose piece 18 for sliding movement thereon. In operation, the contact trip assembly 21 must first be deactivated in order to propel the driver 26 and drive the fastener into the workpiece.

Other operation restricting devices (e.g., mechanical and/or electrical, like switches) may also be provided in the fastener device 10. The contact trip assembly 21 may include a contact trip (or contact trip member) actuatable to initiate the drive stroke. The contact trip may be positioned in front of the driver 26 in the housing 16 of the fastener device 10. The contact trip is configured for movement relative to the housing 16 parallel to the movement of the driver 26. Also, provided are a contact trip spring and a contact trip switch CTS. The contact trip switch CTS is configured such that the contact trip switch CTS may be tripped or actuated (e.g., closed) to allow use of the fastener device 10 (when all conditions are met for driving), and may also be electrically coupled to the controller C. The contact trip switch CTS may be provided in a normally open position and closed when the contact trip spring is compressed by force upon the contact trip itself, for example. In one embodiment, as an operator applies force or bias on the fastener device 10, i.e., towards a workpiece, a contact surface of the contact trip assembly 21 engages the workpiece and then actuates movement of the body of the contact trip relative to the drive channel DC, thereby closing the contact trip switch CTS and spring-loading or compressing the contact trip spring that normally biases the contact trip assembly 21 relatively forward such that the fastener device 10 is disabled from driving.

When the trigger 20 is actuated by the operator's forefinger (e.g., the trigger switch TS is closed) and all other conditions for driving are met, the drive system and thus the motor M may be initiated i.e., activated or energized, to drive a fastener. Such features are known in the art and thus not further described here. That is, the trigger switch TS is configured to generate a trigger signal that may be employed in whole or in part to initiate the cycling of the fastener device 10 to install a fastener to a workpiece.

The contact trip assembly 21 is configured to slide rearwardly in response to contact with a workpiece and may interact with either the trigger 20 or a contact trip sensor/switch CTS. When the contact trip assembly 21 interacts with the trigger 20, the contact trip assembly 21 cooperates with the trigger 20 to permit the trigger 20 to actuate the trigger switch TS to generate the trigger signal. More specifically, the trigger 20 may include a primary trigger, which is actuated by a finger of the user, and a secondary trigger, which is actuated by sufficient rearward movement of the contact trip assembly 21. Actuation of either one of the primary and secondary triggers will not, in and of itself, cause the trigger switch 20 to generate the trigger signal. Rather, both the primary and the secondary trigger must be placed in an actuated condition to cause the trigger 20 to generate the trigger signal. When the contact trip assembly 21 interacts with the contact trip sensor/switch CTS, rearward movement of the contact trip assembly 21 by a sufficient amount causes the contact trip sensor/switch CTS to generate a contact trip signal, which may be employed in conjunction with the trigger signal to initiate the cycling of the fastener device 10 to install a fastener to a workpiece.

The driver 26 includes a driver blade at one end thereof. The driver 26 may be configured for translational movement within the drive channel DC along the drive axis 28. The driver 26 may also be configured to engage with and drive the lead fastener in the drive channel DC into a workpiece. The driver 26 may be made of any number of materials, including, but not limited to, aluminum, nickel, steel, stainless steel, and/or combinations thereof.

A drive system, associated with a drive actuator DA, is configured to selectively drive the driver 26 along the drive axis 28 (or path), to drive the nail or fastener into a workpiece. The drive system (also interchangeably referred to herein as a drive motor assembly), may include the power source or power/energy assembly, the driver 26, an activation arm assembly, and a return mechanism. The activation arm assembly and the return mechanism are described in detail in the incorporated '404 Patent Application.

In one embodiment, the energy/power source/assembly includes the motor M, the flywheel FW, and the drive actuator DA. In one embodiment, the motor M is an outer rotor brushless motor, wherein the rotor is provided on an outside and the stator is provided on an inside thereof. The flywheel FW may be coupled to an output shaft of the motor M. The motor M may be operable for rotating the flywheel FW, for example, via a motor pulley, a belt and a flywheel pulley. The outer rotor of the motor may be integrally formed with the flywheel FW.

In operation, fasteners are stored in the magazine assembly 14, which sequentially feeds the fasteners into the nose assembly 18. The drive motor assembly may be actuated/activated by the controller C to cause the driver 26 to translate and impact a fastener (i.e., in the drive channel DC) in the nose assembly 18 so that the lead fastener may be driven into a workpiece. Actuation of the power source may use energy (e.g., electrical energy from the battery pack 22) to operate the motor M and the drive actuator DA. The motor M is employed to drive the flywheel FW, while the drive actuator DA is configured to (e.g., move a roller that is associated with a roller assembly that configured to) squeeze the driver 26 into engagement with the flywheel FW so that energy may be transferred from the flywheel FW to the driver 26 to cause the driver 26 to translate. The nose assembly 18 (and the drive channel DC) guides the fastener as it is being driven into the workpiece. Actuation of the drive actuator DA causes the roller assembly to translate toward (e.g., in a generally downward direction) and engage the driver 26 to initiate driving engagement between the driver 26 and the flywheel FW and thus move the driver 26 into the drive channel DC of the nose assembly 18 that has a lead fastener therein. The drive actuator DA may be an electro-mechanical actuator such as a linear actuator. In one embodiment, the drive actuator DA is a solenoid. The details about the roller assembly the drive actuator may be found in the '404 Patent Application.

After the driver 26 has translated and driven the fastener from the nose assembly 18, the return mechanism may be employed to return the driver 26 to its starting position. The return mechanism biases the driver 26 into a returned/its starting position. For example, the return mechanism may include a biasing member, or spring, which is configured to push (e.g., backwards) the driver 26 back and away from the nose assembly 18 after the driver 26 is deployed to drive a fastener from the fastener device 10. When the driver 26 has been returned, the solenoid/drive actuator DA may be deactivated. In one embodiment, the drive actuator, the driver, and the drive system used in the fastener device 10 may be an electrical actuator, drive, and drive system and are further described in U.S. Pat. No. 9,744,657 (“the '657 Patent”), which is commonly assigned and is incorporated by reference herein in its entirety.

The fastener device 10 may be an electric fastener device or a pneumatic fastener device. The primary difference between the electric fastener device and the pneumatic fastener device is that the source of power or energy used to drive a fastener in the electric fastening tool is derived from the electric power, rather than pneumatic power. The electric power may be supplied, c.g., by a battery pack 22 or from being plugged into a common household AC outlet.

In one embodiment, the bottom end of the housing 16 may have a removable and rechargeable energy storage device, which may include the battery pack 22. The battery pack 22 may be configured to engage an end portion of the fastener device 10 and provide power to the motor M within the housing 16, such that the fastener device 10 may drive one or more fasteners that are fed from the magazine assembly 14 into a workpiece. The location of the battery pack 22 as shown in the Figures is not limiting and is illustrative only; indeed, the battery pack 22 can be located anywhere on the fastener device 10. In addition, although the energy storage device is illustrated as being a battery pack, embodiments of this disclosure are not limited to battery packs being the energy storage device. That is, in some embodiments, the fastener device 10 may include a cord and a plug for plugging into a common household AC outlet. While the fastener device 10 is described as being electrically powered by a suitable power source or energy storage device, such as the battery pack 22, those skilled in the art will appreciate that the disclosure, in its broader aspects, may apply to other powered fastening tools.

The energy assembly EA includes the motor M and the flywheel FW that is driven by the motor M. The flywheel FW is configured to transmit the power to the driver 26 to thereby cause the driver 26 to translate in the drive channel DC and along the drive axis 28.

The feeder, feed mechanism or feed assembly 110, shown in FIG. 2, may include a feed pawl assembly (not shown) and a follower pawl assembly (not shown). The feed assembly 110 is associated with the magazine assembly 14 and is configured to advance the fasteners contained therein in a feed direction (i.e., towards the drive channel DC, the nose assembly 18 and the driver 26) to present a lead fastener into the nose assembly 18. The feed assembly 110 has feed actuator 148 that is configured to move the lead fastener into the nose assembly 18. A coil or a set of the collated fasteners may be inserted into the canister 200 and an end of the collated fasteners with a lead fastener may be strung towards the drive channel DC such that one of the collated fasteners is positioned in the feed assembly 110 for feeding (e.g., using teeth and/or a pawl assembly, and a feed actuator 148).

In one embodiment, the feed assembly 110 may include a biasing spring and a feed rod configured to move the lead fastener (from the set of collated fasteners contained in the canister 200) into the nosepiece assembly 18. The biasing spring may bias the feed rod into a first position, and the feed actuator 148 may be configured to move (i.c., reciprocate) the feed rod to a second position, against a biasing force of the biasing spring, for moving the lead fastener into the nose assembly 18. In one embodiment, features of the feed assembly 110 may include those of the incorporated '521 reference. The feed actuator 148 may be interchangeably referred to as the feed actuator FA. Like the drive actuator DA, the feed actuator FA may be an electro-mechanical actuator such as a linear actuator. The feed actuator FA may be an electrical actuator. The feed actuator 148/FA may be in the form of a solenoid, in accordance with an embodiment. The features of the feed actuator 148/FA and the feeder/feed assembly 110 may include those of the incorporated '404 Patent Application or the incorporated '521 reference. For example, the feed assembly and feed actuator may be an automatic coil feeder assembly.

In one embodiment, the feeder may include a solenoid/feed actuator. The controller C activates the solenoid. The actual motion of feeding the nails/fastener may be caused by a spring. The spring moves forward and advances the nails/fasteners (e.g., after the solenoid is deenergized). That is, the controller C activates/energizes the solenoid, the spring is then pulled down and then the solenoid is deenergized. This pushes the nail/fastener forward. So, it is the combination of the spring and the solenoid that advance the nails/fasteners. When the solenoid is deenergized, the movement (e.g., forward and advancement) of the nails/fasteners start. The time at which the solenoid is energized may be referred to as the feed cycle start time (i.e., for both the sequential or the bump activation modes).

In one embodiment, in the fastener device 10, the drive actuator DA is positioned on a first axis and the feed actuator FA is positioned on a second axis. These first and second axes are positioned at a non-perpendicular angle relative to one another. In one embodiment, the first (or actuation) axis is positioned such that the axis is parallel to the drive axis 28. In another embodiment, the second (or actuation) axis is parallel to the feed direction (i.e., the axis extending at an angle from near a bottom of the fastener device 10 to the nose assembly 18). In yet another embodiment, the first axis is positioned such that the axis is parallel to the drive axis 28, and the second axis is parallel to the feed direction. In one embodiment, the drive axis 28 of the drive actuator DA is provided in a first plane and an axis of the feed actuator FA defining the feed direction is provided in a second plane, and the first plane is different from the second plane. The axes and planes of the drive actuator DA and the feed actuator FA are also shown and described in the incorporated '404 Patent Application. While the exemplary illustrated embodiments arc described as using solenoids (for the drive and feed actuators DA, FA) as the electro-mechanical actuators, other forms of actuators may be used, for example, an electric motor, a single dual-action solenoid, a multi-stage solenoid, a solenoid in conjunction with a mechanical biasing element, such as a spring, a linear motion machine, or any combination thereof.

The controller C and circuitry may be provided at the back end 52 of the housing 16. The controller C may be provided in the form of a microprocessor and one or more circuit boards, for example, including relay module and one or more MOSFETs. The controller C may also be configured to communicate with the motor M. The controller C may be programmed to provide power and/or control signals (e.g., electric pulses) over control lines to the drive and feed actuators DA and FA. That is, the drive actuator DA and the feed actuator FA are connected to the controller C via control lines. The controller C may be configured to operate both the driver and feeder, to control the start timing of the feeder, etc.

The controller C may be configured to receive input from the trigger 20, which affects movement of the driver 26 and feed rod to load fasteners in the nose assembly 18 of the fastener device 10. Upon receiving a signal from the trigger switch TS and an operation restricting mechanism (e.g., contact trip assembly 21) and its switch CTS, the controller C may be connected to the battery 22 to receive power therefrom and the drive actuator DA may be activated. The controller C may signal the motor M to energize or activate for a predetermined amount of time (e.g., by applying voltage to the motor M) before activating the drive actuator DA. As is understood by a person of ordinary skill in the art, the controller C is configured for outputting a driving control signal to the drive system and for outputting a motor signal to control an operation of the motor M via selectively energizing coils (of the stator) of a plurality of phases of the motor M. In one embodiment, the controller C may include the control unit and/or features of said unit as disclosed in U.S. Pat. No. 10,693,344, which is commonly assigned and is incorporated by reference herein in its entirety.

In one embodiment, the controller C may receive signals (whether the fastener device 10 is in the sequential activation mode or in the bump/contact activation mode and/or one or more characteristics of the energy assembly) and may also receive signals (when the drive cycle was started, and how long the drive cycle will be, etc.). Based on these received signals, the controller C may determine and send signals to the feeder when the solenoid of the feeder should be activated/energized. The time at which the solenoid of the feeder is activated/energized may be referred to as the feeder start time.

The fastener device 10 further comprises one or more sensors S that are configured to sense the characteristic of the energy assembly.

The fastener device 10 may include a sensor configured to sense the speed of the flywheel FW. In one embodiment, the sensor S is configured to sense a condition in the power source that is indicative of a level of kinetic energy of an element in the power source and to generate a sensor signal in response thereto. For example, the sensor S may be operable for sensing a speed of the output shaft of the motor M or a speed of the flywheel FW. As a person of ordinary skill in the art would appreciate from this patent application, the sensor S may sense the characteristic directly or indirectly. For example, the speed of the output shaft of the motor M or the speed of the flywheel FW may be sensed directly, as through encoders, eddy current sensors or Hall effect sensors, or indirectly, as through the back electromotive force of the motor M. Back electromotive force, which is produced when the motor M is not powered by the battery but rather driven by the speed and inertia of the components of the motor assembly (especially the flywheel FW) may be employed.

In another embodiment, a position detector may be associated with the motor M to output a position signal corresponding to the position of a rotor (at one place) of the motor M. The position detector may be a magnetic sensor such as a hall sensor/element or a hall IC, for example, and a hall signal may be output as the position signal. The position signal output from the position detector is input to the controller C. The controller C may include an inverter circuit design to output a control signal to the motor M, to control the rotation of the motor M. In one embodiment, the inverter circuit has six switching elements for supplying driving current to the respective coils of the motor M, wherein three of the switching elements are high-side switching elements and three of the switching elements are low-side switching elements.

When the speed of the flywheel FW is lower than a flywheel speed threshold after the drive cycle, the controller C is configured to increase the time between the drive cycle and the feeder start time. When more time is needed for the speed of the flywheel FW to reach the flywheel speed threshold after the drive cycle, the controller C is configured to increase the time between the drive cycle and the feeder start time. The controller C is configured to determine a flywheel deceleration value based on the speed of the flywheel FW. When the flywheel deceleration value is higher than a predetermined value after the drive cycle, the controller C is configured to increase the time between the drive cycle and the feeder start time.

The fastener device 10 may have multiple modes of operation. For example, one mode of operation of the fastener device 10 may be a sequentialfeed mode (or sequential operation mode) in which the contact trip assembly 21 is first be abutted against a workpiece (so that the contact trip sensor/switch CTS generates the contact trip sensor signal and thereafter the trigger switch TS is actuated to generate the trigger signal).

Another mode of operation of the fastener device 10 may be a mandatory bump feed mode (or bump operation mode) in which the trigger switch TS is first actuated to generate the trigger signal and thereafter the contact trip assembly 21 is abutted against a workpiece so that the contact trip sensor/switch CTS generates the contact trip sensor signal.

Yet another mode of operation may be a combination mode that permits either sequential feed or bump feed wherein no particular sequence is required (i.e., the trigger sensor signal and the contact trip sensor signal may be made in either order or simultaneously).

The fastener device 10 may also include a mode selector switch. The mode selector switch may be a switch that produces a mode selector switch signal that is indicative of a desired mode of operation of the fastener device 10.

The controller C may be configured such that the fastener device 10 will be operated in a given mode, such as the bump feed mode, only in response to the receipt of a specific signal from the mode selector switch. For example, the placement of the mode selector switch in a first position causes a signal of a predetermined first voltage to be applied to the controller C, while the placement of the mode selector switch in a second position causes a signal of a predetermined second voltage to be applied to the controller C. Limits may be placed on the voltage of one or both of the first and second voltages, such as ±a value or a percentage of voltage, so that if the voltage of one or both of the signals is outside the limits the controller C may default to a given feed mode (e.g., to the sequential feed mode) or operation condition (e.g., inoperative).

The fastener device 10 is configured to coordinate the feed cycle and the drive cycle. That is, the fastener device 10 is configured to coordinate the feed cycle and the drive cycle such that the driver 26 is less likely to encounter a jam scenario where the nails/fasteners are being fed into the space that is occupied by the driver blade portion of the driver 26, while the driver 26 is still going through its own motions.

One way the patent application accomplishes this (i.e., prevent a jam) may be through a timing mechanism. For example, the timing mechanism may be electronically controlled. The timing mechanism may be configured to be varied through the microcontroller/controller C. In one embodiment, the controller C is configured to control a time delay between the current/ongoing drive cycle and the next/subsequent feed cycle. The time delay may be interchangeably referred to as a time or a time spacing between the current drive cycle and the next feed cycle.

The driver 26 may include a drive cycle that includes a time from which the driver 26 is activated to engage and drive the fastener in the drive channel DC into the workpiece to a time until the driver 26 is retracted along the drive axis 28 to clear the drive channel DC and to allow for feeding of a subsequent fastener into the drive channel DC. That is, the nail/fastener driving/drive cycle may include time from the activation of the driver mechanism until the driver has partially returned far enough to allow feeding of the next/subsequent nail/fastener (i.e., the drive path is cleared).

The feeder 110 may include a start time defining a time at which the feeder 110 is activated to feed the subsequent fastener into the drive channel DC. That is, the feeding cycle may include the activation of the feeder/feed solenoid and feeding of the next/subsequent nail into the drive path.

In one embodiment, the time between the drive cycle and the feeder start time includes a delay after the drive cycle is completed and before the feeder start time. The controller C is configured to control the time between the drive cycle and the feeder start time based on at least one of a mode of operation of the fastener device 10 and a characteristic of the energy assembly. That is, information or events such as mode of operation/activation mode (bump/contact activation mode vs sequential activation mode), flywheel speed, timing, or calculations of speed/timing can be used to determine and/or set the optimal timing of the nail feeding cycle relative to start of nail driving cycle. The controller C may be configured to receive as input: nailer mode of operation and/or measured system characteristics (e.g., flywheel speed, time, calculation). This (i.e., controlling the time between the current/ongoing drive cycle and the next/subsequent feed cycle) minimizes user/operator frustration due to drive and feed cycle overlap jams. This also minimizes user frustration due to low rate of drive by minimizing delay between drive and feed cycles.

The fastener device 10 may include two modes of operation including a sequential operation mode and a bump operation mode. The controller C is configured to determine whether the fastener device 10 is in the sequential operation mode or the bump operation mode based on the order in which the trigger switch TS and the contact trip switch CTS are actuated. This is described in detail above in this patent application.

The sequential operation mode, the sequential mode, and the sequential activation mode are all interchangeably used in this patent application. In the sequential operation mode, the contact trip 21 is first abutted against the workpiece so that the contact trip switch CTS generates a contact trip signal and thereafter the trigger switch TS is actuated to generate a trigger signal. That is, in sequential mode, the contact trip 21 is depressed before the trigger 20 is pulled. The sequential mode is used for precision or high-power applications. The sequential mode is configured to include a longer drive cycle than that in the bump operation mode.

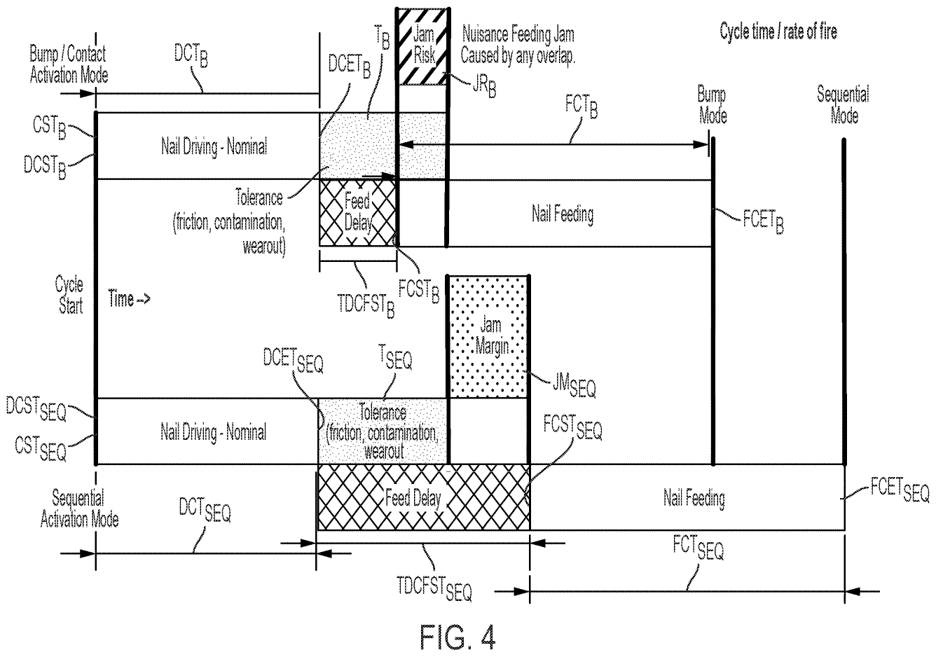

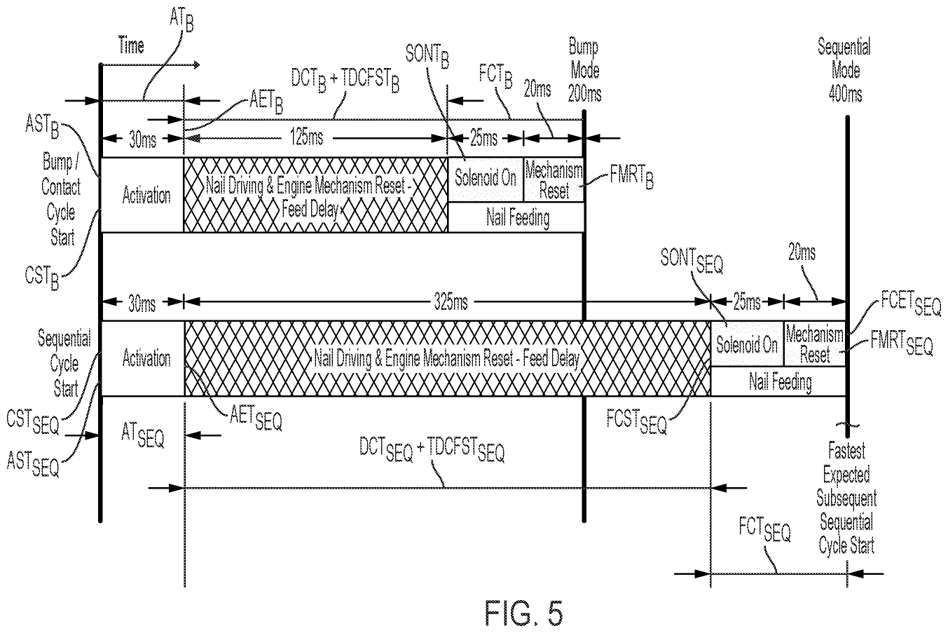

FIGS. 4 and 5 show time taken for various cycles (including activation of the fastener device 10, the drive cycle time, the time between the drive cycle and the feeder start time, the feed cycle time, etc.) for both the sequential operation mode and the bump operation mode. FIGS. 4 and 5 also show the tolerances, the jam risk, the jam tolerances, etc. for each of the sequential operation mode and the bump operation mode.

The tolerance of the sequential activation mode or the bump activation mode may include friction, contamination/contaminants, etc. The tolerance may depend on any given drive event (e.g., in the sequential activation mode or in the bump activation mode), over the course of the life of the fastener device 10, and depending on the conditions in the environment in which the fastener device 10 is being operated in, the way the user/operator uses the fastener device 10, the materials the fastener device 10 is being used on, etc.

In one embodiment, some tolerance to the total amount of time it takes for the driver from the rest position to drive the nail and then to return may be included. That is, some tools drive the nail/fastener completely at the beginning of the illustrated drive cycle. In other cases, if the fastener device 10 has contaminants and is worn out, the fastener device may take that full illustrated drive cycle to complete the drive cycle. So, in the later case/situation, a feed delay may be increased to take into account the jam risk. This may make the fastener drive operate a little bit more slowly just to make sure that it avoids jam risk.

Referring to FIGS. 4 and 5, the sequential activation mode starts at a sequential cycle start time CSTSEQ. FIG. 5 shows the activation time AT_{SEQ} for the fastener device 10 during the sequential activation mode. The activation time AT_{SEQ} for the fastener device 10 during the sequential activation mode may be 30 milliseconds (ms). The activation time AT_{SEQ} for the fastener device 10 may include an activation start time ASTSEQ and an activation end time AET_{SEQ}. The activation start time AST_{SEQ} may be the same as the sequential cycle start time CST_{SEQ}.

As is clear from the discussions in this patent application, in both the bump and sequential activation modes, there are two switches (i.e., contact trip switch CTS and the trigger switch TS) that are closed/depressed so that the time, that is T zero time, would be the point in time that the second of either combination of switches is closed. This may essentially be the cycle start as shown in FIGS. 4 and 5 for both the bump and sequential activation modes. In one embodiment, the controller C may receive three inputs to set off that cycle start. The two inputs may include signals from the two switches (i.e., the contact trip switch CTS and the trigger switch TS) when the switches are depressed/pressed/activated. The third input may include signals from the motor (i.e., the motor is ready, the motor reached its target speed, etc.). The three inputs to the controller C may be the same for the bump and sequential activation modes, except the order in which the two switches (i.e., the contact trip switch CTS and the trigger switch TS) are activated is different for the bump and sequential activation modes as discussed in detail in this patent application.

After the activation time AT_{SEQ}, the sequential activation mode may include the drive cycle time DCT_{SEQ}. The drive cycle time DCT_{SEQ} may include a drive cycle start time DCST_{SEQ} and a drive cycle end time DCET_{SEQ}. The drive cycle start time DCSTSEQ may be the same as the sequential cycle start time CST_{SEQ} or may be the same as the end of the activation time AET_{SEQ}. The drive cycle time DCT_{SEQ} may also include a drive mechanism reset time DMRT_{SEQ}

The drive cycle time DCT_{SEQ} is followed by the time between the drive cycle and the feeder start time TDCFST_{SEQ}. The time between the drive cycle and the feeder start time TDCFST_{SEQ} may include the tolerance and the jam margin for the sequential activation mode. As shown in FIG. 5, the drive cycle time DCT_{SEQ} and the time between the drive cycle and the feeder start time TDCFST_{SEQ} together may be 325 ms.

After the time between the drive cycle and the feeder start time TDCFST_{SEQ}, the sequential activation mode may include a feed cycle time FCT_{SEQ}. The feed cycle time FCT_{SEQ} may include a feed cycle start time FCST_{SEQ} and a feed cycle end time FCET_{SEQ}. The feed cycle start time FCST_{SEQ} may be the same as the end of the time between the drive cycle and the feeder start time TDCFST_{SEQ}. The feed cycle time FCT_{SEQ} may also include a solenoid on time SONT_{SEQ} and a feed mechanism reset time FMRT_{SEQ}. The solenoid on time SONT_{SEQ} may be 25 ms and the feed mechanism reset time FMRT_{SEQ} may be 20 ms.

Referring to FIG. 5, in the sequential activation mode, the total time from the start of the activation time to the end of the feed cycle may be 400 ms, of which the activation time is 30 ms, the drive cycle time (including the driver mechanism reset time) is 280 ms, the time between the drive cycle and the feeder start time is 45 ms, and the feed cycle time (including the solenoid on time of 25 ms and the feeder mechanism reset time of 20 ms) is 45 ms. That is, the drive cycle time (including the driver mechanism reset time) and the time between the drive cycle and the feeder start time together is 325 ms.

Of the two different activation modes, bump activation mode and sequential activation mode, the users have different needs in those two activation modes for how fast the tool operates. So, in the sequential activation mode, the fastener device 10 may take a little more time, work a little slower and it does not have a big impact on the user/operator.

When the fastener device 10 is in the sequential operation mode, the controller C is configured to increase the time between the drive cycle and the feeder start time relative to the time between the drive cycle and the feeder start time in the bump operation mode so as to prevent a jam in the fastener device 10. That is, the time between the drive cycle and the feeder start time in the sequential operation mode is longer than the time between the drive cycle and the feeder start time in the bump mode so as to prevent a jam in the fastener device during the sequential operation mode.

The bump operation mode, the bump mode, the contact mode, the contact operation mode, the bump activation mode and the contact activation mode are all interchangeably used in this patent application. In the bump operation mode, the trigger switch TS is first actuated to generate a trigger signal and thereafter a contact trip 21 is abutted against the workpiece so that the contact trip switch CTS generates a contact trip signal. That is, in bump mode, trigger 20 is pulled before contact trip 21 is depressed. The bump operation mode is used for high rate of drive applications in which a series of fasteners are driven until a predetermined number of fasteners are present in the magazine assembly 14.

Referring to FIGS. 4 and 5, the bump activation mode starts at a bump cycle start time CST_{B} FIG. 5 shows the activation time AT_{B} for the fastener device 10 during the bump activation mode. The activation time AT_{B} for the fastener device 10 during the bump activation mode may be 30 milliseconds (ms). The activation time AT_{B} for the fastener device 10 may include an activation start time AST_{B} and an activation end time AET_{B}. The activation start time AST_{B} may be the same as the sequential cycle start time CST_{B}.

After the activation time AT_{B}, the bump activation mode may include the drive cycle time DCT_{B}. The drive cycle time DCT_{B} may include a drive cycle start time DCST_{B} and a drive cycle end time DCET_{B}. The drive cycle start time DCST_{B} may be the same as the sequential cycle start time CST_{B} or may be the same as the end of the activation time AET_{B}. The drive cycle time DCT_{B} may also include a drive mechanism reset time DMRT_{B}.

The drive cycle time DCT_{B} is followed by the time between the drive cycle and the feeder start time TDCFST_{B}. The time between the drive cycle and the feeder start time TDCFST_{B} may include at least a portion of tolerance for the bump activation mode. As shown in FIG. 5, the drive cycle time DCT_{B} and the time between the drive cycle and the feeder start time TDCFST_{B} together may be 125 ms.

After the time between the drive cycle and the feeder start time TDCFST_{B}, the bump activation mode may include a feed cycle time FCT_{B}. The feed cycle time FCT_{B} may include a feed cycle start time FCST_{B} and a feed cycle end time FCET_{B}. The feed cycle start time FCST_{B} may be the same as the end of the time between the drive cycle and the feeder start time TDCFST_{B}. The feed cycle time FCT_{B} may also include a solenoid on time SONT_{B} and a feed mechanism reset time FMRT_{B}. The solenoid on time SONT_{B} may be 25 ms and the feed mechanism reset time FMRT_{B} may be 20 ms.

Referring to FIG. 4, in the bump activation mode, the feed delay (i.e., the time between the drive cycle and the feeder start time TDCFST_{B}) is not long enough to take makeup for the tolerance. In the bump activation mode, the feed delay may be determined by the competing preferences from the user/operator. In the bump activation mode, the user/operator preferences are weighted differently than in sequential activation mode. So, it would be a matter of the user/operator tolerating that jam risk in the bump activation mode as the use/operator may have a stronger preference for the fastener device 10 to be fast.

Referring to FIG. 5, in the bump activation mode, the total time from the start of the activation time to the end of the feed cycle may be 200 ms, of which the activation time is 30 ms, the drive cycle time (including the driver mechanism reset time) is 80 ms, the time between the drive cycle and the feeder start time is 45 ms, and the feed cycle time (including the solenoid on time of 25 ms and the feeder mechanism reset time of 20 ms) is 45 ms. That is, the drive cycle time (including the driver mechanism reset time) and the time between the drive cycle and the feeder start time together is 125 ms.

When the fastener device is in the bump operation mode, the controller C is configured to reduce the time between the drive cycle and the feeder start time relative to the time between the drive cycle and the feeder start time during the sequential operation mode. The time between the drive cycle and the feeder start time in the bump operation mode is shorter than the time between the drive cycle and the feeder start time in the sequential operation mode.

The controller C is configured to control the time between the drive cycle and the feeder start time based on one or more characteristics of the energy assembly. For example, the one or more characteristics of the energy assembly may include speed of the flywheel FW measured at set time from start, time from start to reach a flywheel speed threshold, calculation of flywheel deceleration, etc.

The controller C is configured to output timing/delay value to start the feed cycle. If the fastener device 10 is operated in the sequential activation mode, a longer delay to the feed cycle is output by the controller C. It is assumed the sequential mode is used for precision or high-power applications with longer drive cycles, not high rate of drive applications. If the fastener device 10 is operated in the bump/contact activation mode, the delay to the feed cycle is minimized. It is assumed the bump/contact activation mode is used for high rate of drive applications.

If a lower flywheel speed after a drive cycle is detected, it is an indication of a high-power application. The controller C is configured to output a long delay to the feed cycle.

If more time is taken to reach a flywheel speed threshold after a drive cycle, it is an indication of a high-power application. The controller C is configured to output a long delay to the feed cycle.

If a higher flywheel deceleration is detected, it is an indication of a high-power application. The controller C is configured to output a long delay to the feed cycle.

If flywheel acceleration and feed cycle elapsed time are predictable, the controller C is configured to set delay such that end of feed cycle and flywheel reaching target speed.

In one embodiment, the time, delay/spacing between the drive cycle and the feeder start time may be preset or predetermined. For example, a preset or predetermined time, delay/spacing between the drive cycle and the feeder start time may be stored in the memory for cach of the modes of the operation. A preset or predetermined time, delay/spacing between the drive cycle and the feeder start time may be stored in the memory for each of the one or more characteristics of the energy assembly.

These preset or predetermined time, delay/spacing between the drive cycle and the feeder start time, stored in the memory, may be used by the controller C based on the mode of operation and/or one or more characteristics of the energy assembly.

In one embodiment, an electronically controlled timing mechanism may be applied to the existing nailer/fastener device. That is, the electronically controlled timing mechanism may be retrofitted to the existing nailer/fastener device. In one embodiment, no new extra sensors are added to the existing nailer/fastener device and any existing sensors in the nailer/fastener device may be used. For example, a simple algorithm may be used to have the static/constant/same delay between the current drive cycle and the next feed cycle based on, for example, only on some input (e.g., the mode of operation of the tool or the one or more characteristics of the energy assembly).

In another embodiment, the time delay/spacing may vary from cycle to cycle. That is, the time delay/spacing may be more dynamically adjusted based on other inputs and sensors that that are available in the nailer/fastener device. The sensors (and its inputs) used for the dynamic adjustment may depend on the type of the nailer/fastener device and the motor in the nailer/fastener device. For example, the motors in the nailer/fastener device may have direct sensors inside of the motor. In another embodiment, some motor may use the coils of the motor to sense its position, its speed, its acceleration, etc. In yet another embodiment, a circuitry for a solenoid controller may be configured to give some feedback as to the positioning and dynamics of the mechanism of the nailer/fastener device. In another embodiment, the sensor may be a direct sensor. The direct sensor may be a hall effect sensor, a sensor with a magnet or an induction sensor.

Another way the patent application may accomplish this (i.e., prevent a jam) may be by detecting the position of the driver blade.

For the sake of completeness, other features may be provided on the fastener device 10. As shown in FIG. 2, for example, a stall release lever 140 may be provided on an outside of the housing 16 to address a stall condition or problem with regards to driving the fastener device 10, e.g., a jam. The stall release lever 140 includes a lever arm 142, a spool, and a flange. The spool and the flange rotate with the lever arm. The stall release lever may be activated by a user/operator in an instance when a drive cycle is not completed. For example, when attempting to drive a nail into a hard material and insufficient power is available to fully sink the nail, the fastener device 10 may stall or jam. Other cases for an incomplete drive cycle may include operational anomalies such as improper nail loading, non-conforming nails being used, or worn or broken components in the tool. In operation, when a stall or jam occurs, the operator may rotate the lever arm in a counterclockwise direction to release the load on the activation system, thereby moving a roller assembly (as described in detail in the incorporated '404 Patent Application) away from the driver 26. Thus, the components in the fastener device 10 are able to return to their respective home positions.

As is generally known, one or more, or all, of the switches mentioned herein may be microswitches.

The present patent application and its various embodiments as described above uniquely address the observed, noted and researched findings and improve on the prior and current state of the art systems. The listed products, features and embodiments as described in the present patent application should not be considered as limiting in any way.

Although the present patent application has been described in detail for the purpose of illustration, it is to be understood that such detail is solely for that purpose and that the present patent application is not limited to the disclosed embodiments, but, on the contrary, is intended to cover modifications and equivalent arrangements that are within the spirit and scope of the appended claims. In addition, it is to be understood that the present patent application contemplates that, to the extent possible, one or more features of any embodiment can be combined with one or more features of any other embodiment.

The illustration of the embodiments of the present patent application should not be taken as restrictive in any way since a myriad of configurations and methods utilizing the present patent application can be realized from what has been disclosed or revealed in the present patent application. The systems, features and embodiments described in the present patent application should not be considered as limiting in any way. The illustrations are representative of possible construction and mechanical embodiments and methods to obtain the desired features. The location and/or the form of any minor design detail or the material specified in the present patent application can be changed and doing so will not be considered new material since the present patent application covers those executions in the broadest form.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,”etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Terms of degree such as “generally,” “substantially,” “approximately,” and “about” may be used herein when describing the relative positions, sizes, dimensions, or values of various elements, components, regions, layers and/or sections. These terms mean that such relative positions, sizes, dimensions, or values are within the defined range or comparison (e.g., cqual or close to equal) with sufficient precision as would be understood by one of ordinary skill in the art in the context of the various elements, components, regions, layers and/or sections being described.

The foregoing illustrated embodiments have been provided to illustrate the structural and functional principles of the present patent application and are not intended to be limiting. To the contrary, the present patent application is intended to encompass all modifications, alterations and substitutions within the spirit and scope of the appended claims.

What is claimed is:

1. A fastener device that drives a fastener into a workpiece comprising:
a housing;
a nose assembly connected with the housing, the nose assembly having a drive channel into which the fastener to be driven into the workpiece is fed,
a driver disposed in the nose assembly, the driver being movable along a drive axis of the nose assembly to engage and drive the fastener in the drive channel into the workpiece, the driver having a drive cycle that includes a time from which the driver is activated to engage and drive the fastener in the drive channel into the workpiece to a time until the driver is retracted along the drive axis to clear the drive channel and to allow for feeding of a subsequent fastener into the drive channel:
an energy assembly disposed within the housing, the energy assembly configured to transmit power to the driver to cause the driver to move along the drive axis;
a feeder configured to feed the fastener into the drive channel of the nose assembly prior to the driver driving the fastener into the workpiece, the feeder having a start time defining a time at which the feeder is activated to feed the subsequent fastener into the drive channel,
a controller having one or more processors and operatively connected to the energy assembly and the feeder, the controller being configured to control a time between the drive cycle and the feeder start time based on at least one of a mode of operation of the fastener device and a characteristic of the energy assembly.

2. The fastener device of claim 1, wherein the fastener device includes two modes of operation including a sequential operation mode and a bump operation mode, and
wherein the controller is configured to determine whether the fastener device is in the sequential operation mode or the bump operation mode based on the order in which a trigger switch and a contact trip switch are actuated.

3. The fastener device of claim 2, wherein, when the fastener device is in the sequential operation mode, the controller is configured to increase the time between the drive cycle and the feeder start time relative to the time between the drive cycle and the feeder start time in the bump operation mode so as to prevent a jam in the fastener device.

4. The fastener device of claim 2, wherein the time between the drive cycle and the feeder start time in the sequential operation mode is longer than the time between the drive cycle and the feeder start time in the bump operation mode so as to prevent a jam in the fastener device during the sequential operation mode.

5. The fastener device of claim 2, wherein, in the sequential operation mode, a contact trip is first abutted against the workpiece so that the contact trip switch generates a contact trip signal and thereafter the trigger switch is actuated to generate a trigger signal.

6. The fastener device of claim 2, wherein the sequential operation mode is used for precision or high-power applications, and
wherein the sequential operation mode is configured to include a longer drive cycle than that in the bump operation mode.

7. The fastener device of claim 2, wherein, when the fastener device is in the bump operation mode, the controller is configured to reduce the time between the drive cycle and the feeder start time relative to the time between the drive cycle and the feeder start time during the sequential operation mode.

8. The fastener device of claim 2, wherein the time between the drive cycle and the feeder start time in the bump operation mode is shorter than the time between the drive cycle and the feeder start time in the sequential operation mode.

9. The fastener device of claim 2, wherein, in the bump operation mode, the trigger switch is first actuated to generate a trigger signal and thereafter the contact trip switch is abutted against the workpiece so that the contact trip switch generates a contact trip signal.

10. The fastener device of claim 2, wherein the bump operation mode is used for applications in which a series of fasteners are driven until a predetermined number of fasteners are present in a magazine.

11. The fastener device of claim 1, wherein the energy assembly includes a motor and a flywheel that is driven by the motor, the flywheel being employed to transmit the power to the driver to thereby cause the driver to translate along the drive axis.

12. The fastener device of claim 11, further comprising a sensor configured to sense the speed of the flywheel,
wherein, when the speed of the flywheel is lower than a flywheel speed threshold after the drive cycle, the controller is configured to increase the time between the drive cycle and the feeder start time, and
wherein, when more time is needed for the speed of the flywheel to reach the flywheel speed threshold after the drive cycle, the controller is configured to increase the time between the drive cycle and the feeder start time.

13. The fastener device of claim 12, wherein the controller is configured to determine a flywheel deceleration value based on the speed of the flywheel,
wherein, when the flywheel deceleration value is higher than a predetermined value after the drive cycle, the controller is configured to increase the time between the drive cycle and the feeder start time.

14. The fastener device of claim 13, further comprising a magazine coupled to the nose assembly and disposed within the housing,
wherein the magazine is configured to carry a supply of fasteners through a feed channel along a feed channel direction toward the nose assembly, and
wherein the feeder is configured to feed the fastener through the magazine and into the drive channel prior to driving the fastener into the workpiece.

15. The fastener device of claim 1, wherein the energy assembly includes a motor and a flywheel that is driven by the motor, the flywheel being employed to transmit the power to the driver to thereby cause the driver to translate along the drive axis, and
wherein the characteristic of the energy assembly includes one or more of the following: a speed of the flywheel, time needed for the speed of the flywheel to reach a flywheel speed threshold and a flywheel deceleration value.
